(19) United States
(12) Patent Application Publication
(10) Pub. No.: US 2014/0229247 A1
(43) Pub. Date: Aug. 14, 2014

(54) GLOBAL TRANSIT CARD SERVICE

(71) Applicant: KT CORPORATION, Gyeonggi-do (KR)

(72) Inventors: Myoung-Hee SEO, Seoul (KR); Dong-Hoon KYE, Seoul (KR); Sung-Chul KIM, Gyeonggi-do (KR); Yong-Joo PARK, Seoul (KR); Youn-Pil JEUNG, Gyeonggi-do (KR); Kook HEO, Seoul (KR)

(73) Assignee: KT CORPORATION, Gyeonggi-do (KR)

(21) Appl. No.: 14/180,843

(22) Filed: Feb. 14, 2014

(30) Foreign Application Priority Data
Feb. 14, 2013 (KR) 10-2013-0016002

(51) Int. Cl. G06Q 20/32

(52) U.S. Cl. CPC G06Q 20/3278
USPC 705/13

(57) ABSTRACT

Described embodiments provide a system and method for a global transit card service. The method may include receiving a global transit card service request from user equipment, where the global transit card service request includes information on a domestic transit card. The method may include transmitting information on an international transit card number for a target roaming area and information on a remaining balance in a foreign currency unit of the target roaming area to the user equipment. The information on the international transit card number of the target roaming area and the remaining balance in the foreign currency unit of the target area may be stored in an international transit card applet included in the user equipment.

### CROSS REFERENCE TO PRIOR APPLICATIONS

The present application claims priority under 35 U.S.C. §119 to Korean Patent Application No. 10-2013-0016002 (filed on Feb. 14, 2013), which is hereby incorporated by reference in its entirety.

The subject matter of this application is related to U.S. patent application Ser. No. 13/949,657 filed Jul. 24, 2013, as Attorney Docket No.: (801.0103), U.S. patent application Ser. No. ______ filed ______, as Attorney Docket No.: (801.0124), U.S. patent application Ser. No. 14/167,272 filed Jan. 29, 2014, as Attorney Docket No.: (801.0125), U.S. patent application Ser. No. ______ filed ______, as Attorney Docket No.: (801.0127), and U.S. patent application Ser. No. 14/161,934 filed Jan. 23, 2014, as Attorney Docket No.: (801.0132), the teachings of which are incorporated herein their entirety by reference.

### BACKGROUND OF THE INVENTION

The present disclosure relates to a transit card service and, more particularly, to a global transit card service that enables a user to use a single transit card not only in a domestic country but also in foreign countries.

A smartphone has been popular because of convenient features. One of them is a transit card feature that allows a user to use the smartphone as a typical transit card for public transportation. For example, such a smartphone supports near field communication and is equipped with a universal subscriber identity module (USIM) card where a transit card applet is installed. The smartphone transmits transit card information to a payment terminal of public transportation when a user taps the smartphone on a payment terminal. The smartphone can be used as a typical transit card to pay a fare for public transportation.

### SUMMARY OF THE INVENTION

This summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with one aspect of the present invention, user equipment equipped may be used as a transit card for public transportation not only in a domestic country but also in foreign countries.

In accordance with another aspect of the present invention, a global transit card service may be provided to enable a user to pay a public transportation fare not only in a domestic country but also in foreign countries with user equipment equipped with a transit card applet.

In accordance with at least one embodiment, a method may be provided for providing a global transit card service. The method may include receiving a global transit card service request from user equipment, where the global transit card service request includes information on a domestic transit card. The method may include transmitting information on an international transit card number for a target roaming area and information on a remaining balance in a foreign currency unit of the target roaming area to the user equipment. The information on the international transit card number of the target roaming area and the remaining balance in the foreign currency unit of the target area may be stored in an international transit card applet included in the user equipment.

The method may include receiving a request for the international transit card applet from the user equipment and providing the request international transit card applet to the user equipment. The user equipment may install the provided international transit card applet.

The domestic transit card information may include at least one of a domestic transit card number, subscriber information, an issue date, an expiration date, a remaining balance, and a security algorithm.

The method may include requesting a user authentication procedure to a transportation service provider server using the domestic transit card information upon the receipt of the global transit card service from the user equipment and determining whether to provide the global transit card service to the subscriber based on a result of the user authentication procedure.

The method may include receiving information on a scheduled roaming area, as the target roaming area, from a subscriber when the user equipment requests the global transit card service through a domestic communication network.

The method may include obtaining information on a current roaming area, as the target roaming area, when the user equipment requests the global transit card service through a foreign communication network. The method may further include obtaining information on transportation service providers in the target roaming area and transmitting the obtained information on the transportation service providers to the user equipment, receiving information on a selected transportation service provider from the user equipment, where the selected transportation service provider is selected based on a selection signal from the subscriber, and obtaining an international transit card number assigned by the selected transportation service provider and a foreign currency exchange rate of the selected transportation service provider upon the receipt of the information on the selected transportation service provider.

The method may include receiving information on a payment made through the international transit card from the user equipment and transmitting the received payment information to the transportation service provider server.

The method may include receiving a request for terminating the global transit card service from the user equipment, calculating a remaining balance of the international transit card in a domestic currency unit upon the receipt of the termination request, and transmitting the information on the calculated remaining balance.

After the receiving the termination request, the method may include obtaining a foreign currency exchange rate from the transportation service provider server and calculating the remaining balance in the domestic currency unit based on the obtained foreign currency exchange rate.

In accordance with another embodiment, a server may be provided for providing a global transit card service. The server may include a communication circuit and a processor. The communication circuit may be configured to receive a global transit card service request including domestic transit card information from user equipment. The processor may be configured to manage a domestic transit card applet and an international transit card applet, to provide the domestic transit card applet and the international transit card applet in user equipment through the communication circuit, and to transmit, to the user equipment, an international transit card number of a target roaming area and a remaining balance of a domestic transit card in response to the global transit card service request. The processor may be configured to obtain information on a current roaming area as information on the target roaming area.

The server may further include a memory configured to store information on transportation service providers of foreign roaming areas, where the transportation service providers are agreed to provide the global transit card service. The processor may be configured to obtain information on transportation service providers of the target roaming area from the memory and transmit the obtained transportation service provider information to the user equipment and to obtain information on the international transit card number assigned by the selected transportation service provider and a foreign currency exchange rate from a transportation service provider server.

The processor may be configured to calculate a remaining balance of the international transit card in a domestic currency unit when receiving a request for terminating the global transit card service from the user equipment and transmit the calculated remaining balance to the user equipment.

In accordance with at least one embodiment, a method may be provided for a global transit card service at user equipment. The method may include obtaining domestic transit card information from a domestic transit card applet included in the user equipment in response to a user input for requesting a global transit card service, transmitting a global transit card service request including the obtained domestic transit card information to a transit card service server, receiving information on an international transit card number of a target roaming area and information on a remaining balance in a foreign currency unit of the target roaming area from the transit card service server, and storing the received information on the international transit card number and the received information on the remaining balance in the foreign current unit in an international transit card applet installed in the user equipment.

The method may include requesting an associated user to enter information on a scheduled roaming area as the target roaming area when the global transit card service is requested through a domestic communication network of the subscriber.

The method may include receiving information on foreign transportation service providers of a scheduled roaming area, which is received from the subscriber, from a transit card service server, requesting the subscriber to select one of the foreign transportation service providers, and transmitting information on a selected foreign transportation service provider to the transit card service server.

The method may include receiving information on foreign transportation service providers of a current roaming area of the user equipment from a transit card service server, requesting the subscriber to select one of the foreign transportation service providers, and transmitting information on a selected foreign transportation service provider to the transit card service server.

The method may include transmitting information on a payment made through the international transit card to a transit card service server.

The method may include detecting the user equipment entering a domestic service area, obtaining international transit card information from the international transit card applet, transmitting a request for terminating a global transit card service to the transit card service server based on the obtained international transit card information, and storing a remaining balance obtained from the transit card service server to the domestic transit card applet in response to the termination request.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 is a diagram illustrating a system for a global transit card service in accordance with at least one embodiment;

FIG. 2 is a diagram illustrating a transit card service server in accordance with at least one embodiment;

FIG. 3 illustrates a method of providing a global transit card service by a transit card service server in accordance with at least one embodiment;

FIG. 4 illustrates a method of user equipment for a global transit card service in accordance with at least one embodiment;

FIG. 5 illustrates requesting a global transit card service in accordance with at least one embodiment;

FIG. 6 illustrates making a payment through an international transit card and processing the payment in accordance with at least one embodiment;

FIG. 7 illustrates terminating a global transit card service in accordance with at least one embodiment;

FIG. 8 illustrates graphic user interfaces produced and displayed on user equipment for requesting a global transit card service in accordance with at least one embodiment; and

FIG. 9 illustrates graphic user interfaces produced and displayed on user equipment for terminating a global transit card service in accordance with at least one embodiment.

### DETAILED DESCRIPTION OF THE INVENTION

Reference will now be made in detail to embodiments of the present invention, examples of which are illustrated in the accompanying drawings, wherein like reference numerals refer to like elements throughout. The embodiments are described below, in order to explain the present invention by referring to the figures.

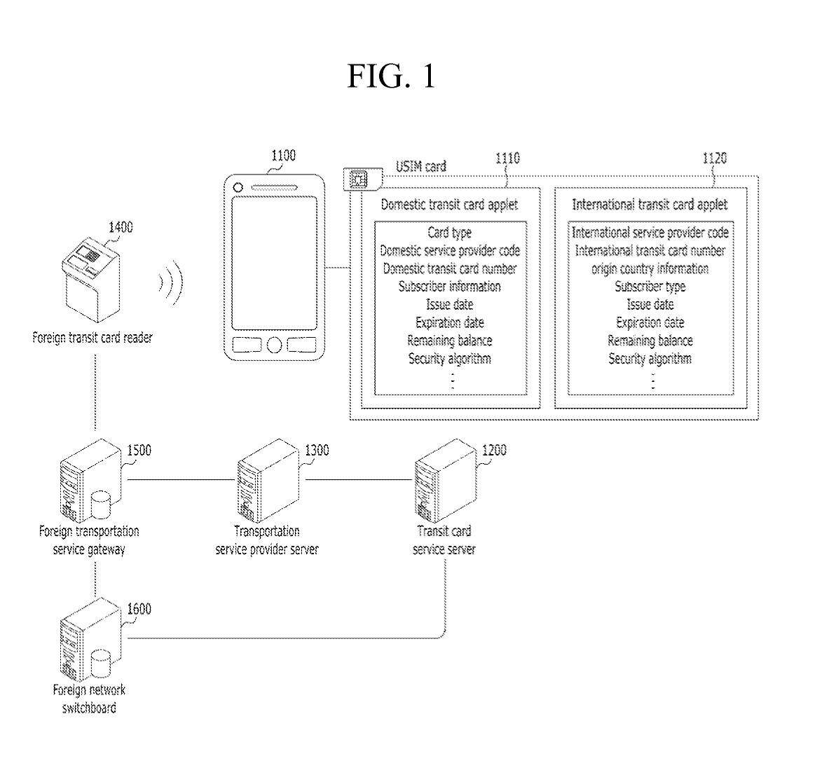

In accordance with at least one embodiment, a service may be provided for allowing a user to use a single transit card at a domestic country and foreign countries. Such a service may be referred to as a global transit card service. Hereinafter, overall operation of such a global transit card service will be described with reference to FIG. 1

FIG. 1 is a diagram illustrating a system for a global transit card service in accordance with at least one embodiment. Referring to FIG. 1, a system may provide a user with a global transit card service that enables a user to pay a transportation fare with user equipment equipped with a transit card applet. Such a system may include user equipment 1100, transit card service server 1200, transportation service provider server 1300, foreign transit card reader 1400, foreign transportation service gateway 1500, and foreign network switchboard 1600. User equipment 110 may include domestic transit card applet 1110 and international transit card applet 1120,

User equipment 1100 may be used to make a payment for a public transportation. For example, user equipment 1100 may establish a wireless communication link to a payment terminal installed at public transportation using a near filed communication (NFC) device and transmit information on an associated payment instrument to the payment terminal through the wireless communication link. User equipment 1100 may be any electronic device which supports the near field communication. For example, user equipment 1100 may include a smartphone, a laptop computer, a personal digital assistant (PDA), a portable multimedia player (PMP), and a navigation device. The present invention, however, is not limited thereto.

User equipment 1100 may further include a wireless communication circuit, an input and output circuit, a memory, a processor, and a power supply. The memory may be used as a data storage device of user equipment 100. The memory may store information necessary for operating user equipment 1100 and performing certain operations requested by a user. The memory may further store various application programs (e.g., app) for providing predetermined services. Such application programs may be executed and perform dedicated operations in response to control of the processor. Particularly, the memory may store a global transit card application for providing a global transit card service that enables a user to make a transit card payment not only in a domestic country but also in foreign countries. In order to provide such a global transit card service, an international transit card applet may be included in user equipment 1100 with a domestic transit card applet.

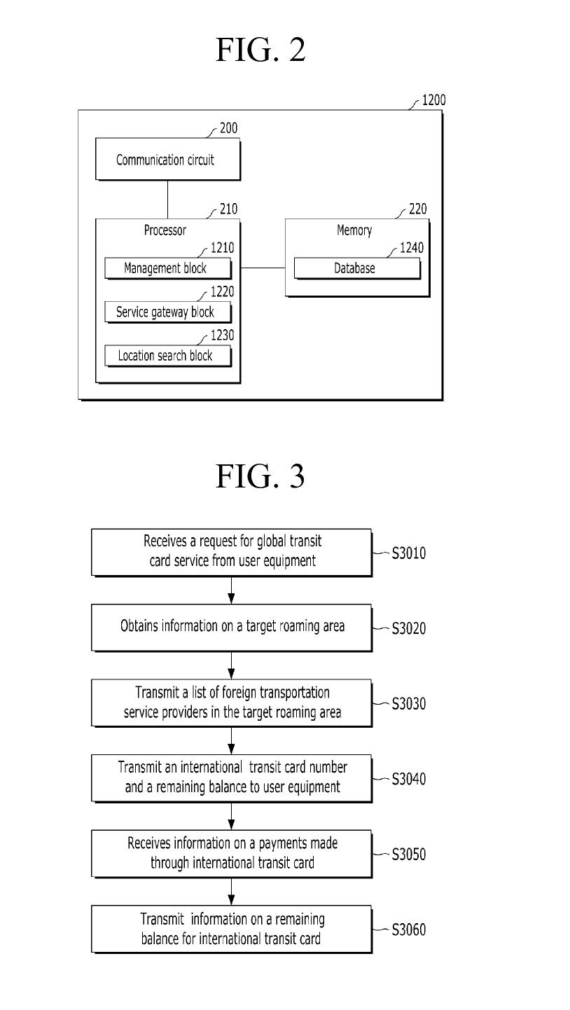

User equipment 1100 may include a universal subscriber identity module (USIM) card. In order to provide such a global transit card service, the USIM card may be installed with domestic transit card applet 1110 and/or international transit card applet 1120 in accordance with at least one embodiment. Domestic transit card applet 1100 and international transit card applet 1120 may be downloaded from a transit card service server and installed in the USIM card. The transit card service server will be described in detail with reference to FIG. 2.

Domestic transit card applet 1110 may be a transit card applet for making a transit payment in a domestic country. Domestic transit card applet 1110 may include information on a domestic transit card service provider code, a domestic transit card number, a subscriber identity (e.g., a general passenger, a student, or a senior), a domestic transit card issue date, a domestic transit card expiration date, a remaining balance, and a security algorithm, but the present invention is not limited thereto.

International transit card applet 1120 may be a transit card applet for making a transit payment for public transportation in predetermined foreign countries adapting a global transit card service standard. International transit card applet 1120 may perform operations based on the global transit card service standard that may be established based on agreements among partnered international transit card service providers and/or partnered international transportation service providers. For example, the global transit card service standard may include Calyso and Felica. When international transit card applet 1120 employs such global transit card standards, international transit card applet 1120 may be issued with a service key (e.g., second management key) by a corresponding international service provider. With such a service key, international transit card applet 112 can operates as a domestic transit card in a corresponding country.

Intentional transit card applet 1120 may include information on an international transit card provider code, a transit card number for international roaming, information on subscriber's origin country, a passenger type (e.g., a general passenger, a student, a senior, and a military), an issue date, an expiration date, a balance, and a security algorithm. The subscriber's origin country may be obtained from the transit card number in domestic transit card applet 1110. Alternatively, a country code may be obtained from an associated communication network. The issue date in the international transit card applet 1120 may be a date when an associated user requests for international roaming, and the expiration date may be a date when the associated user ends the international roaming. The balance in international transit card applet 1120 may be the balance in the domestic transit card applet 1110 exchanged in a relevant currency.

Transit card service server 1200 may provide domestic transit card applet 1110 and/or international transit card applet to user equipment 1100. For example, user equipment 1100 may download domestic and international transit card applet 1110 and 1120 from international card service server 1200 and installs them in the USIM card.

Transit card service server 1200 may perform operations for providing a related service based on the global transit card service standards. In order to provide the global card service, transit card service server 1200 may manage a plurality of servers and systems based on partnership agreements among domestic and foreign countries.

In addition, transit card service server 120 may collect information on payments made by subscribers using international transit card applet 1120 in foreign countries. Such transit card service server 1200 may be operated in various manners. Particularly, transit card service server 120 may be managed by a wireless network provider. Additionally, transit card service server 1200 may be coupled with transportation service provider server 1300 for providing a domestic transit card service.

Although transit card service server 1200 is illustrated as an independent server in FIG. 1, the present invention is not limited thereto. Transit card service server 1200 may be a server system including a number of different computing systems physically coupled to achieve various different functions. Such transit card service server 1200 will be further described in detail with reference to FIG. 2.

Transportation service provider server 1300 may support an international roaming service (e.g., a global transit card service) of a domestic transit card applet in connection with user equipment 1100 (e.g., a domestic transportation service subscriber) and transit card service server 1200.

In accordance with at least one embodiment, transportation service provider server 1300 may allocate a predetermined range of transit card numbers for international transit cards of partnered foreign transit card service providers. Transportation service provider server 1300 may manage the allocated international transit card numbers. Transportation service provider server 1300 may assign one of available international transit card numbers to foreign subscriber (e.g., user equipment 1100) upon the receipt of a global transit card service request.

Transportation service provider server 1300 may further provide other information necessary to support the global transit card service. For example, transportation service provider server 1300 may provide a security algorithm and/or currency exchange rate to user equipment 1100 via transit card service server 1200.

Furthermore, transportation service provider server 1300 may carry out a user authentication procedure and may receive information on payments made in foreign countries. Transportation service provider server 1300 may also perform confirmation and management of a user identity and manage a remaining balance of each subscriber.

As shown in FIG. 1, transportation service provider server 1300 may be illustrated as a separate standalone server, but the present invention is not limited thereto. Transportation service provider server 1300 may include a number of different servers physically coupled to provide various different functions of transportation service provider server 1300.

Foreign transit card reader 1400 may be a transit card reader provided and managed by a partnered foreign transit card service provider. For example, Foreign transit card reader 1400 may detect an international transit card number when user equipment 1100 having international transmit card applet 1120 is located within a predetermined distance. Upon the detection, foreign transit card reader 1400 may receive information on a payment instrument (e.g., international transit card number and a remaining balance) from international transit card applet 1120 and process a payment made through international transit card applet 1120.

Foreign transportation service gateway 1500 may process a payment made through international transit card applet 1120 in connection with transportation service provider server 1300. Foreign network switchboard 1600 may be referred to a switchboard of a foreign communication service provider. Foreign network switchboard 1600 may manage data roaming in connection with systems of a domestic communication service provider. In accordance with at least one embodiment, transit card service server 1200 may receive information on payments made by user equipment 1100 via foreign network switchboard 1600.

FIG. 2 is a diagram illustrating a transit card service server in accordance with at least one embodiment. Referring to FIG. 2, transit card service server 1200 may be a server of a transit card service provider. Such transit card service server 1200 may be a computing system for providing a related service. For example, transit card service server 1200 may provide domestic transit card applet 1110 and/or international transit card applet to user equipment 1100. Transit card service server 1200 may perform operations for providing a related service based on the global transit card service standards. In addition, transit card service server 120 may collect information on payments made by subscribers using international transit card applet 1120

Such Transit card service server 1200 may include communication circuit 200, processor 210, and memory 220. Processor 210 may include functional blocks including management block 1210, service gateway block 1220, and location search block 1230. Memory 220 may include database 1240.

Communication circuit 200 transmits signal to and receives signals from other entities (e.g., user equipment 1100, transportation service provider server 1300, foreign transportation service gateway 1500, and foreign network switch board 1600) through a communication network based on various types of communication schemes. Communication circuit 200 may be referred to as a transceiver and include at least one of a mobile communication circuit, a wireless internet circuit, a near field communication (NFC) circuit, a global positioning signal receiving circuit, and so forth.

Processor 210 may perform operations for managing transit card applets. Such operation may be performed through management block 1210 of processor 210. For example, processor 210 may manage and provide a domestic transit card applet and an international transit card applet. For example, processor 210 (e.g., management block 1210) may transmit a domestic transit card applet and an international transit card applet to user equipment 1100 upon a request. Upon the receipt of the domestic transit card applet and/or the international transit card applet, user equipment 1100 may install the received applets in a USIM card thereof.

For example, when a request for a global transit card service is made from user equipment 1100 installed with domestic transit card applet 1110, user equipment 1100 may determine whether international transit card applet 1120 is installed in a USIM card thereof. When international transit card applet 1120 is not installed in user equipment 1100, user equipment 1100 may make an installation request of international transit card applet 1120 to transit card service server 1200. In response to the request, processor 210 (e.g., management block 1210) may transmit international transit card applet 1120 and install the requested applet on the USIM card of user equipment 1100.

Furthermore, processor 210 (e.g., management block 1210) may issue and manage a first management key. The first management key may be shared with partnered transportation service providers. The transportation service providers may update their transit card applet with the first management key in order to provide a transit card service.

Processor 210 may perform operations for issuing an international transit card number through service gateway block 1220. For example, processor 210 (e.g., service gateway block 1220) may receive a request for a global transit card service from user equipment 1100 and transmit international transit card numbers usable in a requested roaming area of user equipment 1100. The requested roaming area may be a current roaming area where user equipment 1100 is located or a roaming area where user equipment 1100 will be located. Service gateway block 1220 may also transmit information on a remaining balance of an associated domestic transit card in a foreign currency unit of the requested roaming to user equipment 1100.

In accordance with at least one embodiment, such a global transit card service request may include information recorded in domestic transit card applet 1110. For example, the request may include a domestic transit card number, user information, an issue date and expiration date of a transit card, a security algorithm, and/or a requested and a currently roaming area.

Upon the receipt of the global transit card service request, processor 210 (e.g., service gateway block 1220) may request a transportation service provider server to perform an authentication process using the received information in the global transit card service request. Processor 210 (e.g., service gateway block 1220) may determine whether to provide the global transit card service to user equipment 110 based on the authentication result from the transportation service provider server.

Such a global transit card service request may be received through one of a domestic communication network and a foreign communication network according to a location of a subscriber (e.g., user equipment 1100). When the global transit card service request is received through the domestic communication network, processor 210 (e.g., service gateway block 1220) may receive information on a scheduled roaming area, which will be entered by an associated user, as the target roaming area. When the global transit card service request is received through a foreign communication network, processor 210 (e.g., location search block 2130) may detect a current location of user equipment 1100 as a target roaming area.

Processor 120 (e.g., service gateway block 1220) may obtain information on the target roaming area for user equipment 1100 based on the scheduled roaming area information included in the global transit card service request or based on based on the current location of user equipment 1100 determined by location search block 1230. After obtaining the target roaming area, processor 120 (e.g., service gateway block 1220) may determine foreign transportation service providers of the target roaming area based on information stored memory 220 (e.g., database (DB) 1240). Processor 120 (e.g., service gateway block 1220) may transmit the information on the determined foreign transportation service providers (e.g., a list of transportation service providers) of the target roaming area to user equipment 1100. Based on such information, user may be able to select a preferred transportation service provider from the received list.

Memory 220 (e.g., database 1240) may store information on partnered transportation service providers of each roaming area (international service area). In accordance with at least one embodiment, such transportation service provider information may include a mobile country code (MCC), a mobile network code (MNC), a transit card service provider code, and/or information on partnership agreements, such as a duration of the partnership or a priority among other partnered transit card service providers.

In accordance with at least one embodiment, processor 210 (e.g., service gateway block 1220) receives information on the selected transportation service provider from user equipment 1100, processor 210 (e.g., service gateway block 1220) may obtain a international transit card number assigned by the selected transportation service provider from transportation service provider server 1300. Processor 210 (e.g., service gateway block 1220) may also obtain information on a foreign currency unit of the target roaming area from transportation service provider server 1300 associated with the selected transportation service provider. Based on the obtained information on a foreign currency unit, processor 210 (e.g., service gateway block 1200) provide information on a remaining balance of the associated domestic transit card in the foreign currency unit of the target roaming area to user equipment 1100.

Processor 210 (e.g., service gateway block 1220) may receive information on payments made by user equipment 1100 in an international roaming area and deliver the received information to transportation service provider server 1300. The payment information may include, but not limited to, a payment date and time, a payment amount, and remaining balances.

Upon the receipt of a request for terminating a global transit card service from the user equipment 1100, processor 210 (e.g., service gateway block 1220) may compute a remaining balance of an international transit card in a domestic currency unit and transmit information on the computed remaining balance to user equipment 1100.

FIG. 3 illustrates a method of providing a global transit card service by a transit card service server in accordance with at least one embodiment.

At step 3010, a request for a global transit card service is received. For example, transit card service server 1200 receives a request for a global transit card service from user equipment 1100. The request may include, but not limited to, information on a domestic transit card of user equipment 1100. Such domestic card information may be obtained from the domestic transit card applet 1110 installed on a USIM card of user equipment 1100. The domestic transit card information may include, but not limited to, a domestic transit card number, subscriber identity, an issue date of a transit card, an expiration date of a transit card, a remaining balance, a security algorithm, and/or a requested roaming area.

In accordance with at least one embodiment, user equipment 1100 may request an international transit card applet to transit card service server 1200 before the global transit card service request. In response to the request for the international transit card applet, transit card service server 1200 may provide the international transit card applet 1120 on the USIM card in the user equipment 1100.

Furthermore, once the global transit card service request is received from user equipment 1100, transit card service server 1200 may request transportation service provider server 1300 to confirm a subscriber (e.g., user equipment 1100) using the domestic transit card information included in the global transit card service request. That is, transit card service server 1200 may perform an authentication process using the domestic transit card information. Based on the confirmation result from transportation service provider server 1300, transit card service server 1200 may determine whether to provide the global transit card service to user equipment 1100.

At step 3020, information on a target roaming area is obtained. For example, transit card service server 1200 may obtain information on a target roaming area. The target roaming area may be a scheduled roaming area where an associated subscriber (e.g., user equipment 1100) will be located in a scheduled time. In this case, information on the target roaming area may be entered by a subscriber of user equipment 110 and transit card service server 1200 receives the global transit card service request through a domestic server (e.g., domestic communication network). That is, when transit card service server 1200 receives the global transit card service request through a domestic server (e.g., domestic communication network), transit card service server 1200 obtains information on the target roaming area from the domestic transit card information included in the global transit card service request.

Furthermore, the target roaming area may be a current roaming area of user equipment 1100. In this case, transit card service server 1200 receives the global transit card service request through a foreign server (e.g., foreign communication network). That is, when transit card service server 1200 receives the global transit card service request through a foreign server (e.g., foreign communication network), transit card service server 1200 obtains information on the target roaming area from an associated foreign server.

At step 3030, information on foreign transportation service providers is provided to user equipment 110. For example, transit card service server 1200 may search foreign transportation service providers in the target roaming area and provide a list of the searched transportation service providers to user equipment 1100.

At step 3040, information necessary for a global transit card service is obtained from a foreign transportation service server selected by an associated subscriber (e.g., user equipment 1100). For example, the associated subscriber (e.g., user equipment 1100) selects one of the foreign transportation service providers in the list and transmits the selected foreign transportation service provider to transit card service server 1200. Upon the receipt, transit card service provider 1200 obtains information necessary for providing a global transit card service from associated transportation service provider server 1300. The obtained information may include, but not limited to, an international transit card number assigned by the selected foreign transportation service provider and a currency exchange rate with respect to the target roaming area.

Based on the obtained information, transit card service server 1200 may compute a remaining balance in associated domestic transit card applet 1110 in a currency unit of the target roaming area and transmit the obtained information (e.g., the assigned international transit card number) to user equipment 1100. Furthermore, transit card service server 1200 may store information on at least one of the assigned international transit card number and the foreign currency exchange rate in a memory.

User equipment 1100 receives the information on the assigned international transit card number and the remaining balance and stores them in international transit card applet 1120 installed on the USIM card. Use equipment 1100 activates international transit card applet 1120 in order to enable the subscriber to make a payment.

At step 3050, information on a payment made through user equipment 1100 is received. For example, when the associated subscriber makes the payment using user equipment 1100, transit card service server 1200 receives such payment information. Transit card service server 1200 may transmit the received payment information to transportation service provider server 1300.

At step 3060, a request for terminating the global transit card service is received. For example, transit card service server 1200 receives the global transit card service terminating request from user equipment 1100. Upon the receipt of the global transit card service terminating request, transit card service server 1200 computes the remaining balance in an origin currency unit and transmits the computed remaining balance to user equipment 1100. Transit card service server 1200 may obtain a currency exchange rate from transportation service provider server 1300.

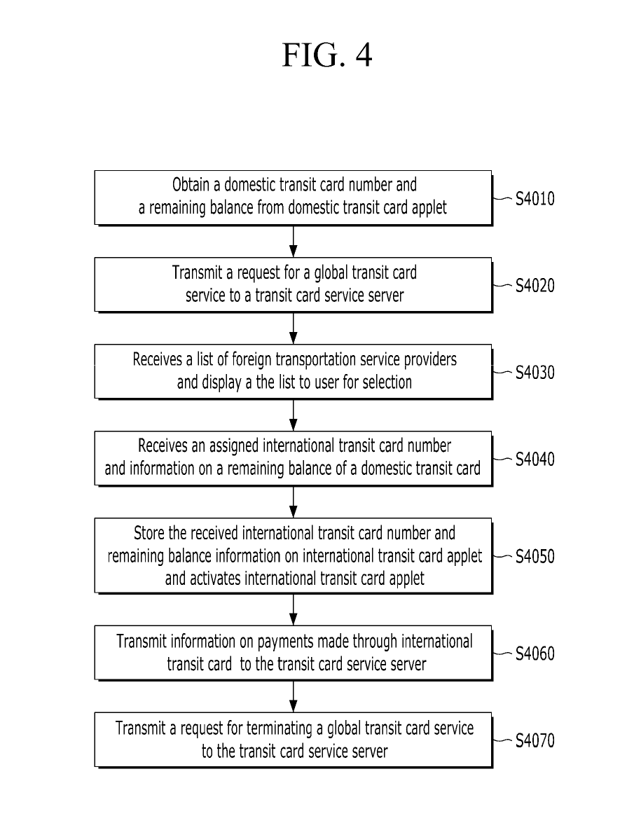

FIG. 4 illustrates a method of user equipment for a global transit card service in accordance with at least one embodiment.

At step 4010, information on a domestic transit card is obtained upon a global transit card service request. For example, user equipment 1100 receives an input from a subscriber for requesting a global transit card service. Upon the request, user equipment 1100 obtains domestic transit card information from domestic transit card applet 1100 installed on a USIM card. The domestic transit card information may include, but not limited to, a domestic card number, a remaining balance, a transit card service provider code, issuer information, an issue and expiration date of a transit card, a security algorithm.

At step 4020, the global transit card service request is transmitted to transit card service server 1200. For example, user equipment 1110 transmits the global trait car service request with the obtained domestic transit card information to transit card service server 1200. In accordance with at least one embodiment, when the subscriber makes the global transit card service request via a domestic server (e.g., a domestic communication network), user equipment 1100 may request the subscriber to input a target roaming area (e.g., a scheduled roaming area).

At step 4030, information on foreign transportation service providers in the target roaming area is received in response to the global transit card service request. For example, user equipment 1100 receives a list of available transportation service providers in the target roaming area from transit card service server 1200 in response to the global transit card service request. Based on the received information, the associated subscriber may be enabled to choose one of the foreign transportation service providers in the received list. User equipment 1100 may transmit information on the selected foreign transportation service provider to transit card service server 1200. Furthermore, user equipment 1100 may store the information on the selected foreign transportation service provider in international transit card applet 1120.

At step 4040, information on an assigned international transit card number is received. For example, user equipment 1100 receives an international transit card number assigned by the selected foreign transportation service provider from transit card service server 1200. User equipment 1100 also receives information on a remaining balance of an associated domestic transit card in a foreign currency unit of the target roaming area.

At step 4050, the received information is stored and an international transit card applet is initiated. For example, user equipment 1100 stores the received information in international transit card applet 1120 installed in the USIM card. User equipment 1100 activates international transit card applet 1200.

At step 4060, information on a payment made through the international transit card applet is transmitted to transit card service server 1200. For example, user equipment 1100 transmits information on payments made through the international transit card number stored in international transit card applet to transit card service server 1200. The payment result information may be transmitted regularly at a predetermined interval or upon the generation of a predetermined event.

At step 4070, a request for terminating a global transit card service is transmitted to transit card service server 1200. For example, when the subscriber (e.g., user equipment 1100) returns to a domestic server area, user equipment 1100 may transmit a global service terminating request to transit card service server 1200. User equipment 1100 may obtain information on international transit card applet 1120 and transmit the obtained information to transit card service server 1200 with the global service terminating request. User equipment 1100 may receive information on a remaining balance from transit card service server 1200, stores the received information in domestic transit card applet 1110, and activate domestic transit card applet 1110.

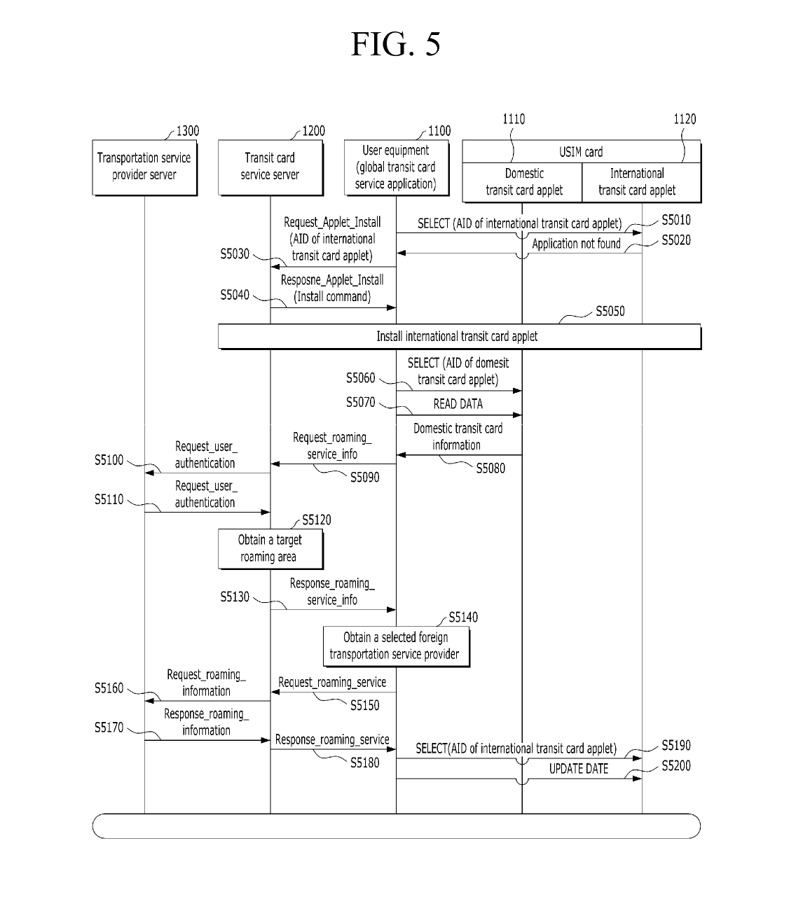

FIG. 5 illustrates requesting a global transit card service in accordance with at least one embodiment.

Referring to FIG. 5, a subscriber activates a global transit card service application installed in user equipment 1100 to request the global transit card service at step S5010. Such operation may be performed through executing a function “SELECT ( )” with an application identification number (AID) of international transit card applet 1120.

Through the executed global transit card service application, user equipment 1100 may determine whether a corresponding international transit card applet is installed in user equipment 1100. If the international transit card applet is not installed at step S5020, user equipment 1100 requests transit card service server 1200 for the corresponding international transit card applet at step S5030. Such request may be performed through executing a function “Request Applet Install” with an application identification number (AID) of international transit card applet 1120. In response to the request, transit card service server 1200 may provide the requested international transit card applet to user equipment 1100 at step S5040. Such response may be made through executing a function “Response_Applet_install (install commands).” User equipment 1100 installs the provided international transit card applet at step S5050.

At step S5060, user equipment 1100 activates domestic transit card applet 1110 through executing a function “SELECT (AID)” with an application identification number (AID) of domestic transit card applet 1110. At step S5070, user equipment 1100 reads information on a domestic transit card from activated domestic transit card applet 1110. Such operation may be performed through executing a function of “READ DATA”. At step S5080, user equipment 1100 obtains the domestic transit card information from domestic transit card applet 1110. For example, the domestic transit card information may include, but not limited to, a domestic transit card number, subscriber identity, an issue date of a transit card, an expiration date of a transit card, a remaining balance, a security algorithm, and/or a requested roaming area. At step S5090, user equipment 1100 transmits the obtained domestic transit card information to transit card service server 1200 and requests international roaming service information to transit card service server 1200. Such request may be made through executing a function of “Request_roaming_service_info”.

At step S5100, transit card service server 1200 requests transportation service provider server 1300 to perform an authentication process using the received domestic transit card information. Such operation may be performed through a function “Request_user_authentication”. At step S5110, transit card service server 1200 receives the authentication result from transportation service provider server 1300. Such operation may be performed through a function “Response_user_authentication”.

At step S5120, transit card service server 1200 may obtain information on a target roaming area. When user equipment 1100 request the global transit card service through a domestic communication network, user equipment 1100 may request the associated subscriber to enter a target roaming area through the executed global transit card service application. When user equipment 1100 request the global transit card service through a foreign communication network, transit card service server 1200 may obtain the information on the target roaming area from the foreign communication network through location search block 1230.

At step S5130, transit card service server 1200 obtains and provides information on foreign transportation service providers in the target roaming area to user equipment 1100. Such operation may be performed through a function of “Response_roaming_service_info”.

At step S5140, through the executed global transit card application, user equipment 1100 provides the received information on the foreign transportation service providers and receives information on a selected foreign transportation service provider. At step S5150, user equipment 1100 transmits a global transit card service to transit card service server 1200. Such operation may be performed through a function of “Request_roaming_service”. User equipment 1100 also transmit information (e.g., parameters) on the selected foreign transportation service provider code, a domestic transit card number, and a remaining balance thereof, which may be obtained from domestic transit card applet 1110, to transit card service server 1200 with the request.

At step S5160, transit card service server 1200 request information for the global transit card service in the target area to transportation service provider server 1300. Such operation may be performed through a function of “Request_roaming_information”. The request may be transmitted with information (e.g., parameters) on the domestic transit card number, the selected foreign transportation service provider code, and the target roaming area.

At step S5170, transportation service provider server 1300 transmits information on an international transit card number for the selected foreign transportation service provider and a corresponding foreign currency exchange rate to transit card service server 1200. Such operation may be performed through a function of “Response_roaming_information”.

At step S5180, transit card service server 1200 transmits information on a remaining balance in a corresponding foreign currency unit, the international transit card number, and information necessary for the global transit card service to user equipment 1100. The necessary information may include information on a security algorithm and a list of commands of associated international transit card applet (e.g., update command list). Such operation may be performed through a function of “Response_roaming_service”.

At step S5190, user equipment 1100 activates international transit card applet 1120 through executing a function of “SELECT (AID)” with the application identification number (AID) of international transit card applet 1120.

At step S5200, user equipment 1100 updates international transit card applet 1120 with the information received from transit card service server 1200 through a function of “UPDATE DATA”.

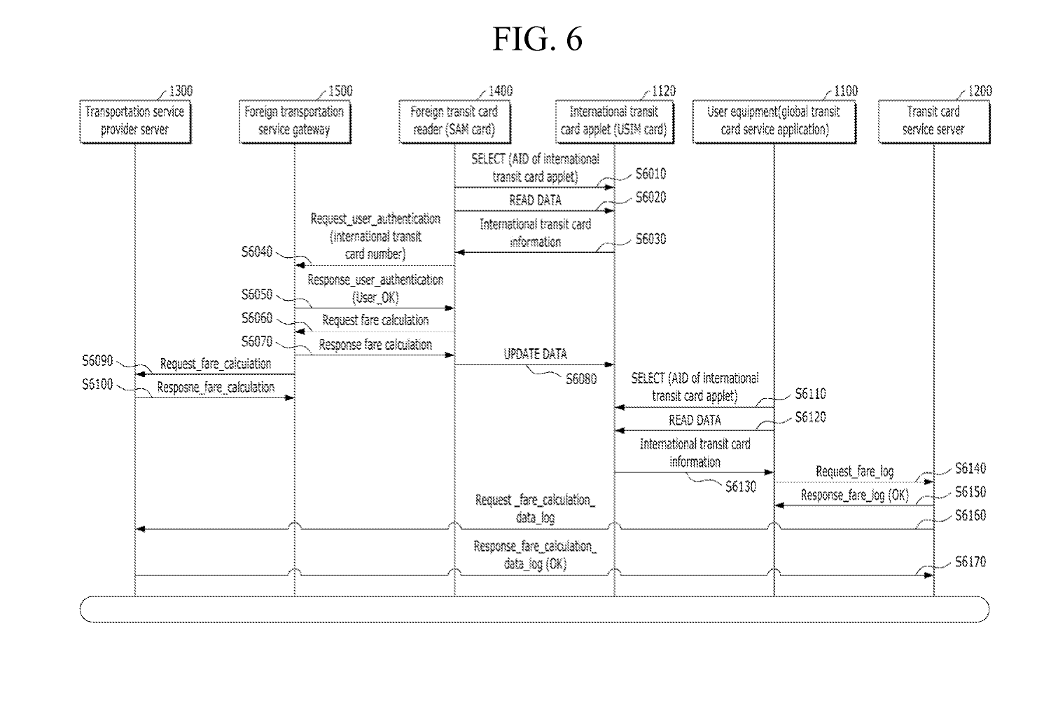

FIG. 6 illustrates making a payment through an international transit card and processing the payment in accordance with at least one embodiment.

Referring to FIG. 6, when a user wants to make a payment (a transportation fare) in a foreign country, the user may tap user equipment 1100 on a payment terminal (e.g., foreign transit card reader 1400) of a public transportation (e.g., a bus, a subway, or a train). Upon such a tapping operation, user equipment 1100 activates international transit card applet 1120 (e.g., SELECT (AID)), obtains information on the international transit card (e.g., READ DATA), and transmits the obtained information to foreign transit card reader 1400 (e.g., a card type, an international transit card number, a service provider code, a country code, subscriber information, an issued date, an expiration date, and a security algorithm) at steps S6010, S6020, and S6030. Such information may be encrypted and the encrypted information may be decoded by a SAM card of foreign transit card reader 1400.

At steps S6040 and S6050, foreign transit card reader 1400 requests an authentication procedure to foreign transportation service gateway 1500 and receives the authentication result from foreign transportation service gateway 1500 (Request_user_authentication and Response_user_authentication).

At step S6060, foreign transit card reader 1400 requests a payment process (fare calculation) to foreign transportation service gateway 1500 by transmitting the international transit card information of user equipment 1100 (Request_fare_calculation). At step S6070, foreign transit card reader 1400 receives a payment process result (fare calculation result) from foreign transportation service gateway 1500 when foreign transit card reader 1400 is interacted with foreign transportation service gateway 1500 in real time. At step S6080, foreign transit card reader 1400 updates the remaining balance in international transit card applet 1120 (UPDATE DATA). When foreign transit card reader 1400 is not interacted with foreign transportation service gateway 1500 in real time, foreign transit card reader 1400 deducts the processed fare amount from the remaining balance of international transit card applet 1120 after performing an offline authentication process with a SAM card.

At step S6090, when a card number of requested payment process is an international transit card number, foreign transportation service gateway 1500 transmits the calculation information (payment information) to transportation service provider server 1300 (Request_fare_calculation). At step S6100, transportation service provider server 1300 performs fare calculation using the received calculation information (Response_fare_calculation).

At steps S6110 to S6150, user equipment 1100 (e.g., global transit card service application) obtains information on a payment made through international transit card applet 1120 whenever the payment is made from international transit card applet 1120 and transmits the obtained information (e.g., international transit card number, payment date, fare amount, and remaining balance) to transit card service server 1200.

At steps S6160 and S6170, transit card service server 1200 transmits a transaction history (payment log) to a domestic transportation service server at a predetermined interval defined by a corresponding policy (e.g., regularly or a time of releasing a roaming service). Such updated information (e.g., transaction history or payment log) may be used for payment data confirmation.

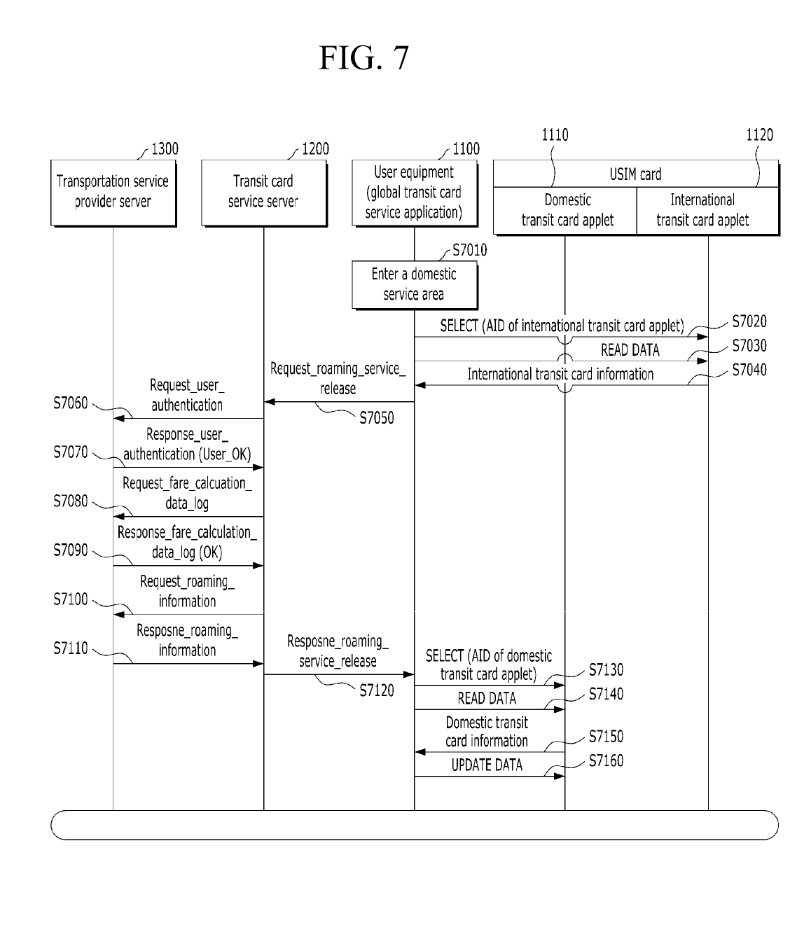

FIG. 7 illustrates terminating a global transit card service in accordance with at least one embodiment.

Referring to FIG. 7, user equipment 1100 (e.g., a global transit card service application) recognizes entering of a domestic service area at step S7010. At steps S7020 to S7040, user equipment 1100 obtains the international transit card information from international transit card applet 1120 (SELECT ( ) and READ DATA ( )). The international transit card information may include a service provider code, an international transit card number, subscriber information, an issue date, an expiration date, and a remaining balance. At step S7050, user equipment 1100 (e.g., global transit card service application) request termination of the global transit card service to transit card service server 1200 (Request_roaming_service_release). Upon the request, user equipment 1100 transmits the obtained international transit card information (e.g., a service provider code, an international transit card number, subscriber information, an issue date, an expiration date, and a remaining balance) to transit card service server 1200.

At steps S7060 and S7070, transit card service server 1200 requests an authentication procedure of a corresponding subscriber to transportation service provider server 1300 and receives the authentication result from transportation service provider server 1300 (Request_user_authentication, Response_user_authentication). Additionally, transit card service server 1200 may request a transaction history (e.g., fare calculation data log) of a corresponding subscriber to transportation service provider server 1300 and receive the requested transaction history (Request_fare_calculation_data_log, Response_fare_calculation_data_log) at steps S7080 and S7090.

At steps S7100 and S7110, transit card service server 1200 requests information for releasing the global transit card service to transportation service provider server 1300 and receives the request information from transportation service provider server 1300 (Request_roaming_information, Reseponse_roaming_information). At step S7120, transit card service server 1200 transmits the obtained information, information on a remaining balance in a domestic currency unit, and a update command list for a domestic transit card applet to user equipment 1100 (Response_roaming_service_release).

At steps S7130 to S7160, user equipment 1100 (e.g., global transit card service application) obtains the domestic transit card information, determines whether the received subscriber information from transit card service server 1200 is identical to that in the obtained domestic transit card information, and updates the remaining balance (SELECT ( ), READ DATA, UPDATE DATA).

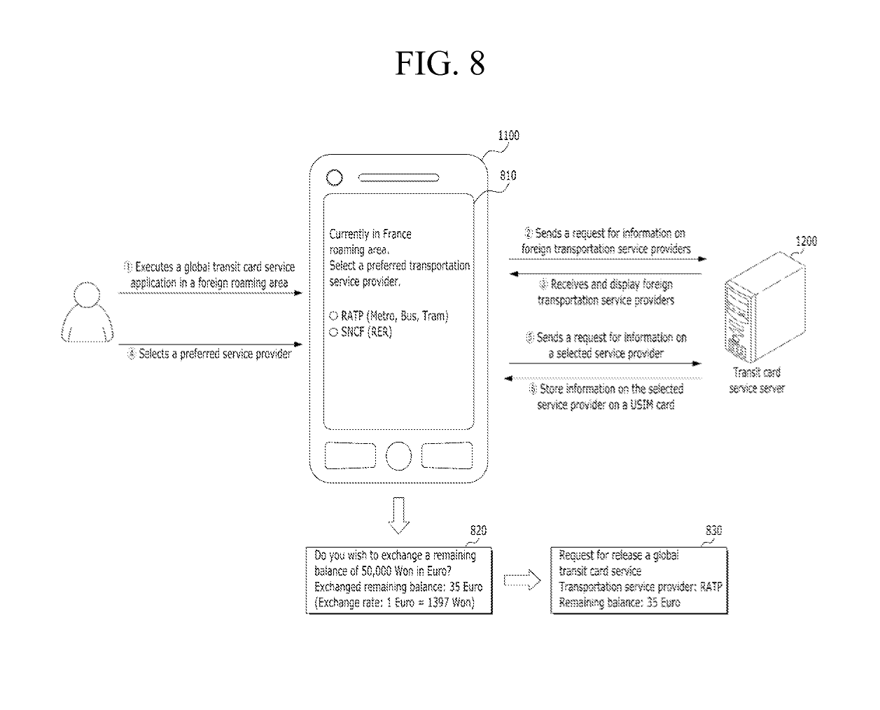

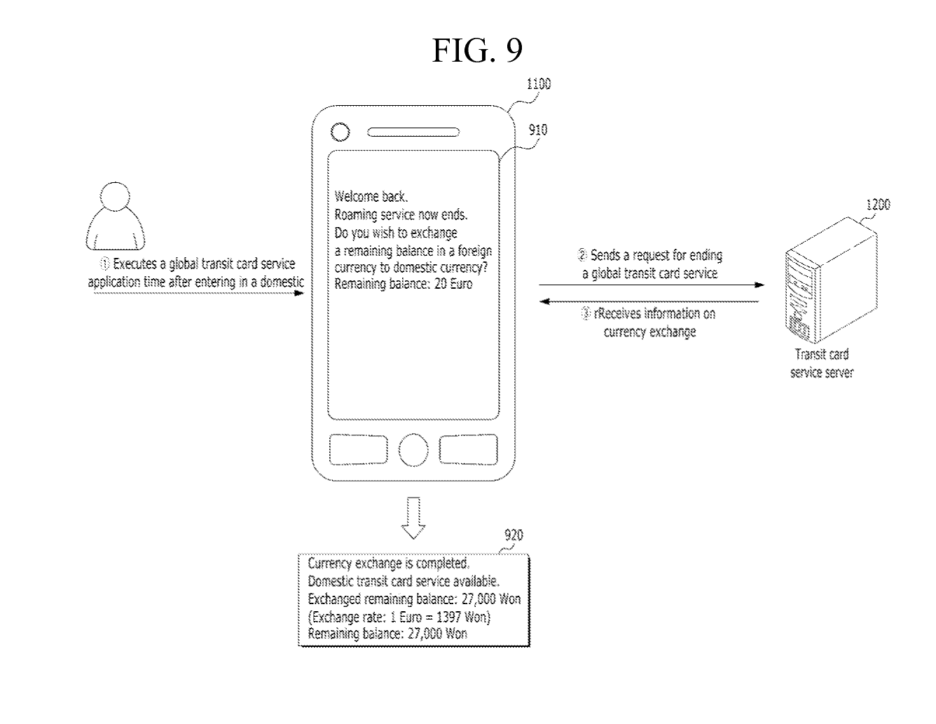

FIG. 8 illustrates graphic user interfaces produced and displayed on user equipment for requesting a global transit card service in accordance with at least one embodiment.

Referring to FIG. 8, a user activates a global transit card service application installed in user equipment 1100 at a foreign communication network and requests a global transit card service (1). User equipment 1100 requests information on a list of transportation service providers in a target roaming area to transit card service server 1200 (2).

User equipment 1100 receives the transportation service provider information from transit card service server 1200 and displays graphic user interface 810 showing the received transportation service provider information and enabling the user to select one of them.

User equipment 1100 receives a user selection input for selecting one of the transportation service providers (4) and requests international transit card information of the selected transportation service provider to transit card service server 1200 (5). User equipment 1100 receives the request international transit card information and foreign currency exchange rate information from transit card service server 1200 and store the received information on international transit card applet 1120 (6).

As shown in 820 and 830, user equipment 1100 displays foreign currency exchange rate and a remaining balance (820) and displays a message of completion of the global transit card service.

FIG. 9 illustrates graphic user interfaces produced and displayed on user equipment for terminating a global transit card service in accordance with at least one embodiment.

Referring to FIG. 9, a subscriber enters a domestic service area and executes a global transit card service application installed in user equipment 1100 (1). User equipment 1100 displays graphic user interface 910 for informing the termination of the global transit card service and for enabling the subscriber to exchange a remaining balance to a domestic currency.

When the subscriber wants to exchange, user equipment 1100 requests the termination of the global transmit card service to transit card service server 1200 (2) and receives information on the remaining balance in the domestic currency unit from transit card service server 1200 (3). The received information is displayed as shown in graphic user interface 920.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of providing a global transit card service, the method comprising:
receiving a global transit card service request from user equipment, where the global transit card service request includes information on a domestic transit card; and
transmitting information on an international transit card number for a target roaming area and information on a remaining balance in a foreign currency unit of the target roaming area to the user equipment,
wherein the information on the international transit card number of the target roaming area and the remaining balance in the foreign currency unit of the target area are stored in an international transit card applet included in the user equipment.

2. The method of claim 1, comprising:
receiving a request for the international transit card applet from the user equipment; and
providing the request international transit card applet to the user equipment,
wherein the user equipment installs the provided international transit card applet.

3. The method of claim 1, wherein the domestic transit card information includes at least one of a domestic transit card number, subscriber information, an issue date, an expiration date, a remaining balance, and a security algorithm.

4. The method of claim 1, comprising:
requesting a user authentication procedure to a transportation service provider server using the domestic transit card information upon the receipt of the global transit card service from the user equipment; and
determining whether to provide the global transit card service to the subscriber based on a result of the user authentication procedure.

5. The method of claim 1, comprising:
receiving information on a scheduled roaming area, as the target roaming area, from a subscriber when the user equipment requests the global transit card service through a domestic communication network.

6. The method of claim 1, comprising:
obtaining information on a current roaming area, as the target roaming area, when the user equipment requests the global transit card service through a foreign communication network.

7. The method of claim 5, comprising:
obtaining information on transportation service providers in the target roaming area and transmitting the obtained information on the transportation service providers to the user equipment;
receiving information on a selected transportation service provider from the user equipment, where the selected transportation service provider is selected based on a selection signal from the subscriber; and
obtaining an international transit card number assigned by the selected transportation service provider and a foreign currency exchange rate of the selected transportation service provider upon the receipt of the information on the selected transportation service provider.

8. The method of claim 1, comprising:
receiving information on a payment made through the international transit card from the user equipment; and
transmitting the received payment information to the transportation service provider server.

9. The method of claim 1, comprising:
receiving a request for terminating the global transit card service from the user equipment;
calculating a remaining balance of the international transit card in a domestic currency unit upon the receipt of the termination request; and
transmitting the information on the calculated remaining balance.

10. The method of claim 9, after the receiving the termination request, comprising:
obtaining a foreign currency exchange rate from the transportation service provider server; and
calculating the remaining balance in the domestic currency unit based on the obtained foreign currency exchange rate.

11. A server comprising:
a communication circuit configured to receive a global transit card service request including domestic transit card information from user equipment; and
a processor configured to:
manage a domestic transit card applet and an international transit card applet,
provide the domestic transit card applet and the international transit card applet in user equipment through the communication circuit, and
transmit, to the user equipment, an international transit card number of a target roaming area and a remaining balance of a domestic transit card in response to the global transit card service request.

12. The server of claim 11, wherein the processor is configured to:
obtain information on a current roaming area as information on the target roaming area.

13. The server of claim 11, further comprising:
a memory configured to store information on transportation service providers of foreign roaming areas, where the transportation service providers are agreed to provide the global transit card service,
wherein the processor is configured to:
obtain information on transportation service providers of the target roaming area from the memory and transmit the obtained transportation service provider information to the user equipment; and
obtain information on the international transit card number assigned by the selected transportation service provider and a foreign currency exchange rate from a transportation service provider server.

14. The server of claim 11, wherein the processor is configured to
calculate a remaining balance of the international transit card in a domestic currency unit when receiving a request for terminating the global transit card service from the user equipment; and
transmit the calculated remaining balance to the user equipment.

15. A method of a global transit card service at user equipment, the method comprising:
obtaining domestic transit card information from a domestic transit card applet included in the user equipment in response to a user input for requesting a global transit card service;
transmitting a global transit card service request including the obtained domestic transit card information to a transit card service server;
receiving information on an international transit card number of a target roaming area and information on a remaining balance in a foreign currency unit of the target roaming area from the transit card service server; and
storing the received information on the international transit card number and the received information on the remaining balance in the foreign current unit in an international transit card applet installed in the user equipment.

16. The method of claim 15, comprising:
requesting an associated user to enter information on a scheduled roaming area as the target roaming area when the global transit card service is requested through a domestic communication network of the subscriber.

17. The method of claim 15, comprising:
receiving information on foreign transportation service providers of a scheduled roaming area, which is received from the subscriber, from a transit card service server;
requesting the subscriber to select one of the foreign transportation service providers; and
transmitting information on a selected foreign transportation service provider to the transit card service server.

18. The method of claim 15, comprising:
receiving information on foreign transportation service providers of a current roaming area of the user equipment from a transit card service server;
requesting the subscriber to select one of the foreign transportation service providers; and
transmitting information on a selected foreign transportation service provider to the transit card service server.

19. The method of claim 15, comprising:
transmitting information on a payment made through the international transit card to a transit card service server.

20. The method of claim 15, comprising:
detecting the user equipment entering a domestic service area;
obtaining international transit card information from the international transit card applet;
transmitting a request for terminating a global transit card service to the transit card service server based on the obtained international transit card information; and
storing a remaining balance obtained from the transit card service server to the domestic transit card applet in response to the termination request.
